(19) United States
(12) Patent Application Publication
(10) Pub. No.: US 2024/0053769 A1
(43) Pub. Date: Feb. 15, 2024

(54) METHOD AND SYSTEM FOR CONTROLLING THE FLIGHT PATH OF AN AERIAL VEHICLE

(71) Applicant: MDGROUP GERMANY GMBH, Siegen (DE)

(72) Inventors: Nicolas Seube, Siegen (DE); Elliot Mugner, Siegen (DE); Michael Pontz, Siegen (DE); Francois Darmayan, Siegen (DE)

(21) Appl. No.: 18/265,384

(22) PCT Filed: Dec. 8, 2021
(86) PCT No.: PCT/EP2021/084771

§ 371 Date: Jun. 5, 2023

(30) Foreign Application Priority Data
Dec. 9, 2020 (EP) 20212818.7

(51) Int. Cl. G05D 1/06

(52) U.S. Cl. CPC G05D 1/0646; B64U 10/13

(57) ABSTRACT

A method and system for controlling the flight path of an aerial vehicle measures a distance between the aerial vehicle in flight and a plurality of points to obtain a point cloud of point position data. A first contour line corresponding to the topographical ground and a second contour line corresponding to a top line of objects on the ground are segmented from the point cloud. Data representing the first contour line and/or data representing the second contour line is processed in a control unit of the aerial vehicle for determining a control signal for the aerial vehicle. The flight path of the aerial vehicle includes a first section in which the vertical position of the aerial vehicle is determined relative to the first contour line, and a second section in which the vertical position of the aerial vehicle is determined relative to the second contour line.

### BACKGROUND

The invention relates to a method and a system for controlling the flight path of an aerial vehicle.

Information on the distance between an aerial vehicle in flight and the ground can be relevant for navigating the aerial vehicle. For example, the aerial vehicle can be controlled to maintain a defined vertical distance above ground on its flight path.

When measuring the distance between the aerial vehicle and the ground there may be abrupt changes in the measured distance, because for example a first measurement provides the distance between the aerial vehicle and the top of a tree or a building, while a second measurement provides the distance between the aerial vehicle and the topographical ground.

Using the distance data of the aerial vehicle in flight for the purpose of controlling the flight position of the aerial vehicle sometimes leads to undesired results. If for example it is intended that the aerial vehicle has a flight path at a defined vertical distance above ground a measurement of the distance between the aerial vehicle and a tree top may result in an undesired increase in the vertical position of the aerial vehicle corresponding to the height of the tree.

### SUMMARY

The invention is based on the object of presenting a method and a system for controlling an aerial vehicle along a flight path with an improved vertical distance to the ground. Proceeding from the prior art specified, the object is achieved by the features of the independent claims. Advantageous embodiments are specified in the dependent claims.

In the inventive method a distance between the aerial vehicle in flight and a plurality of points is measured for obtaining a point cloud of point position data. A first contour line and a second contour line are segmented from the point cloud, wherein the first contour line corresponds to the topographical ground and the second contour line corresponds to a top line of objects on the ground. Data representing the first contour line and/or data representing the second contour line is processed in a control unit of the aerial vehicle for determining a control signal for the aerial vehicle. The height of the flight path of the aerial vehicle is controlled with the control signal.

A point cloud representing a plurality of points can be analyzed in order to differentiate between a first set of points corresponding to the topographical ground and a second set of points corresponding to the upper end of objects on the ground like trees or buildings. From the first set of points a first contour line corresponding to the topographical ground can be determined. From the second set of points a second contour line can be determined. The second contour line can correspond to a top line of objects on the ground.

The first contour line and the second contour line can be used for navigating the aerial vehicle as needed. For example, if the aerial vehicle has a flight mission requiring a constant vertical distance above topographical ground, the data representing the first contour line can be processed in the control unit for the purpose of controlling the flight height of the aerial vehicle. In another example, the second contour line can be used to steer the aerial vehicle at a constant vertical distance from objects on the ground. According to another example the aerial vehicle may have the flight mission to inspect a power line. The data representing the second contour line can be processed in the control unit for the purpose of steering the aerial vehicle at a constant vertical distance from the power line.

More generally speaking, the flight path of the aerial vehicle can include a first section in which the vertical position of the aerial vehicle is determined relative to the first contour line. The flight path of the aerial vehicle can include a second section in which the vertical position of the aerial vehicle is determined relative to the second contour line. The flight path of the aerial vehicle can include a third section in which the vertical position of the aerial vehicle is determined relative to the first contour line and relative to the second contour line. The flight path can include one or more of the first section, the second section and the third section in arbitrary sequence.

For the step of obtaining a point cloud an aerial vehicle being in flight can send a measuring beam towards the ground. In particular, the measuring device of the aerial vehicle can comprise a light source for emitting the measuring beam and one or more optical elements to deflect the measuring beam in different directions for scanning towards the ground. Reflected portions of the measuring beam can be analyzed for determining the coordinates of the position on the ground from which the measuring beam was reflected. The coordinates can be coordinates in an aircraft-related coordinate system. By sending the measuring beam in different directions a point cloud representing coordinates of a plurality of positions on the ground can be obtained. The measuring system of the aerial vehicle can be a LiDAR system.

The point cloud can be obtained in a short period of time so that the position of the aerial vehicle relative to the Earth can be considered to be constant during the measurement. In this case the spatial relation of the points within the point cloud corresponds to the spatial relation of the objects in the scanned region on the ground. It is possible to extract points from the point cloud corresponding to the forward-looking measuring beams. In the case of a multi-layer LiDAR system, forward looking beams are the one corresponding to layers oriented towards the track of the aerial vehicle. In the case of a rotating prism or a Risley prism LiDAR, forward looking beam can be selected by using the angle to the center axis of each beam, in a scanning sector oriented towards the track of the aerial vehicle. The point cloud originating from a forward-looking scanning sector of the optical device is called a scanline.

Within a scanline known mathematical methods can be applied for identifying a first contour line and a second contour line. Such mathematical methods are devoted to the classification between ground and non-ground points or more generally to the detection of the top envelope of objects lying on the ground. Example of method that can be used are active contour methods as described in Elmqvist, M., Jungert, E., Lantz, F., Persson, A., Soderman, U., “Terrain modelling and analysis using laser scanner data,” International Archives of Photogrammetry and Remote Sensing, 22 24 (2001). Alternative methods are wire simulation, linear or planar segmentation methods for determining the ground as a plane or a linear profile, iterative triangulation methods and adaptive interpolation methods. The first contour line can be a continuous line or a polyline delineating ground points. The second contour line can be a continuous line or a polyline delineating the highest points of objects. The mathematical algorithm can be fed with further conditions. For example, a minimum value can be predefined for the vertical distance between the first contour line and the second contour line.

Interpolation can be applied to close gaps in the first contour line and/or the second contour line, in cases where no points are available in the point cloud. It is also possible to have an interrupted first contour line and/or second contour line if no appropriate points for closing the gap are available in the point cloud. This might be the case if the aerial vehicle is operated under conditions where there are no returns from the optical measuring beams from the ground or where the measuring beam scans an object that covers the complete scanning region of the measuring device, like the roof of a large building. In such situation the scanned region may include areas in which only one of the first contour line and the second contour line is present.

The first and/or second contour line can be determined along a predefined track on the ground. Preferably, the track on the ground is identical for the first contour line and the second contour line. The track on the ground can correspond to the actual path of the aerial vehicle. The vertical distance between the flight mission path and the ground can be larger than the vertical distance between the second contour line and the first contour line.

In one embodiment the track on the ground corresponding to the flight mission path can be predefined and the information from the contour lines is only used for determining the vertical position along the predefined track. In such case obtaining only first and second contour lines corresponding to the track of the flight mission path can be sufficient.

In one embodiment the inventive method is used for defining the lateral position of the flight mission path, which means that information from the first contour line and/or the second contour lines is used to determine the track over ground of the aerial vehicle. If for example the second contour line indicates the presence of a very high building the aerial vehicle can be navigated laterally around the building.

Lateral navigation information can be determined by identifying a plurality of first contour lines and second contour lines corresponding to different areas on the ground. In one embodiment the method comprises the step of identifying a first contour surface and/or a second contour surface, wherein the first contour surface and the second contour surface cover an area on the ground. Within the meaning of the invention a contour line is an element of a contour surface. If a full two-dimensional contour of the ground as well as a contour of the upper ends of objects on the ground is provided, a more advanced route planning can be performed with for example the purpose of avoiding unnecessary changes in height of the aerial vehicle during the flight mission.

The mathematical operation for identifying first and second contour lines within the point cloud is preferably applied to a scanline, in which the spatial relation is directly correlated to the scanned region. A scanline is inherently referenced if the aircraft has a fixed position in an Earth-related coordinate system during the measurement, which is a reasonable assumption with regards to the scanline acquisition time by the measuring device.

The aircraft can include an Inertial Measurement Unit (IMU) for measuring the orientation of the aircraft relative to the Earth or a linear acceleration and angular velocity of the aircraft. If the orientation of the aircraft is known the points of the point cloud can be corrected from the orientation of the aircraft by timestamps in order to obtain a point cloud in a local-leveled frame. Based on the timestamp the point cloud can be referenced in order to provide an appropriate basis for identifying the first and second contour lines.

The operation of the aerial vehicle is controlled by control signals from a control unit. The control unit may be an element of the aerial vehicle. The use of a remote control including the control unit or including components of the control unit is also possible. The control unit processes input data from e.g., sensors or the navigation system of the aerial vehicle to provide control signals by which drive components of the aerial vehicle are controlled. For example, a control signal can transmit the information to a motor of the aerial vehicle to increase or reduce the rotational speed.

The control signals from the control unit can be used for guiding the aerial vehicle along a desired flightpath. The desired flightpath can be a predefined flightpath that is provided to the control unit as an input information. The first and second contour lines can be processed in the control unit for the purpose of flying at a given relative height from objects on the ground. If the pre-defined flightpath includes positions that are lower than the second contour line the control unit can deny the request to fly along this flightpath in order to avoid a collision with objects. Alternatively, the drive unit can be configured to automatically alter the flightpath to avoid a conflict with the second contour line if possible.

It is also possible that the first and second contour lines are processed in the control unit for the purpose of finding an energy-saving flight path. In a conventional flight mission, the aerial vehicle can have a flightpath that is determined by a certain vertical distance above ground. If the aerial vehicle measures the distance to the ground and there is a tree having a height of 10 m on the track of the flightpath the aerial vehicle will ascend by 10 m before the tree and descend by 10 m after the tree is passed. This can waste a consider-able amount of energy. From the inventive contour lines the control unit is provided with the information that the tree is only in object on the ground and that no change in flight altitude is needed for flying over the tree.

Another option might be a flight mission where the aerial vehicle is controlled to stay 10 m above ground without colliding with buildings. The aerial vehicle can automatically follow the streets between the buildings by al-lowing only flightpaths, where the second contour line is interrupted by at least 10 m.

In one embodiment the flightpath provided to the control unit comprises a first section and a second section, wherein in the first section the vertical position of the aerial vehicle is defined relative to the first contour line and in the second section the vertical position of the aerial vehicle is defined relative to the second contour line. For example, it is the object of the flight mission to examine the condition of trees the aerial vehicle can be controlled to fly 30 m above ground (first contour line) until the trees to be examined are reached and then can be controlled to fly 10 m higher than the top of the trees (second contour line).

In another example it may be the object of the flight mission to examine the condition of a power line. In a first section of the flightpath the aerial vehicle can be controlled to stay 20 m above ground (first contour line) until the power line is reached and then be controlled to maintain a constant vertical distance of 20 m relative to the power line (second contour line).

The inventive method can be performed online, which means that the ground position data obtained at a point in time is used for controlling the flight path in a section of the flightpath directly subsequent to the point in time. The delay between obtaining the ground position data and control signals for the aerial vehicle determined from the ground position data can be less than 2 seconds, preferably less than 1 seconds, more preferably less than 0.5 seconds.

The invention also relates to a system for controlling the flight path of an aerial vehicle. The system comprises a measuring device for measuring a distance between the aerial vehicle in flight and a plurality of measured points for obtaining a point cloud of point position data. The system comprises a computation module for segmenting a first contour line and a second contour line from the point cloud, wherein the first contour line has a vertical position that is different from the vertical position of the second contour line. The system comprises a control unit adapted to process data representing the first contour line and/or data representing the second contour line for determining a control signal and adapted to control the flight path of the aerial vehicle with the control signal.

The system can be developed with further features which are described in the context of the inventive method. The method can be developed with further features which are described in the context of the inventive system.

### BRIEF DESCRIPTION OF THE DRAWINGS

In the following, the invention is described in exemplary fashion on the basis of advantageous embodiments, with reference being made to the attached drawings. In detail:

FIG. 1: shows an inventive aerial vehicle in the process of obtaining a point cloud of position data;

FIG. 2: a point cloud obtained with the measurement of FIG. 1;

FIG. 3: first and second contour lines segmented from the point cloud of FIG. 2;

FIG. 4: relative height with respect to ground and object represented in an across track view, as computed from the contour lines from FIG. 3;

FIG. 5: a schematic illustration of an inventive aerial vehicle;

FIG. 6: a block diagram of the aerial vehicle of FIG. 4;

FIG. 7-9: different flightpaths determined on the basis the first and second contour lines of FIG. 3;

FIG. 10: and inventive aerial vehicle in operation;

FIG. 11: an inventive aerial vehicle scanning the ground using a Risley prism LiDAR;

FIG. 12 an inventive aerial vehicle scanning the ground using a multi-layer rotating LiDAR.

### DETAILED DESCRIPTION

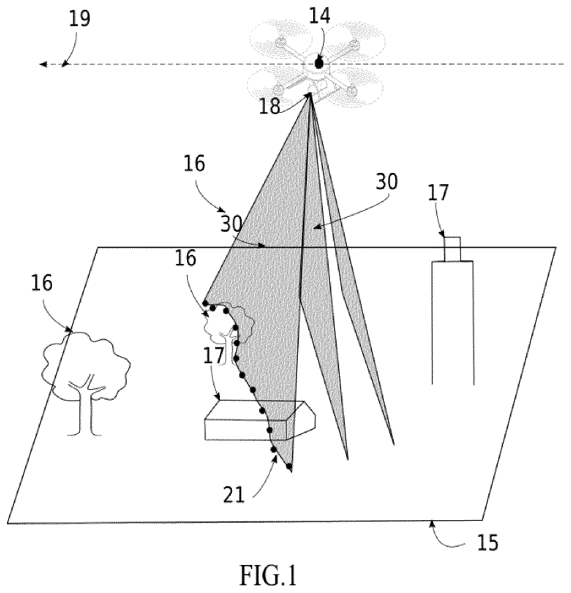

An unmanned aerial vehicle (UAV) 14 is shown in FIG. 1 being in flight above a region on the ground 15. The scanned region on the ground 15 includes a plurality of objects like trees 16 and buildings 17. The UAV 14 is operated remotely by a ground-based operator (not shown). The operator uses a remote control for controlling the UAV 14 via a radio frequency (RF) link. Mission planning information including flight control and operating instructions for the UAV 14 are either stored in a controller memory of the remote control or a in controller within a body of the UAV 14. The UAV 14 carries a measuring device in form of a LiDAR system 18. The LiDAR system 18 comprises a LASER scanner, an Inertial Measurement Unit (IMU), and a GNSS receiver. The LiDAR system 18 is powered by the UAV 14.

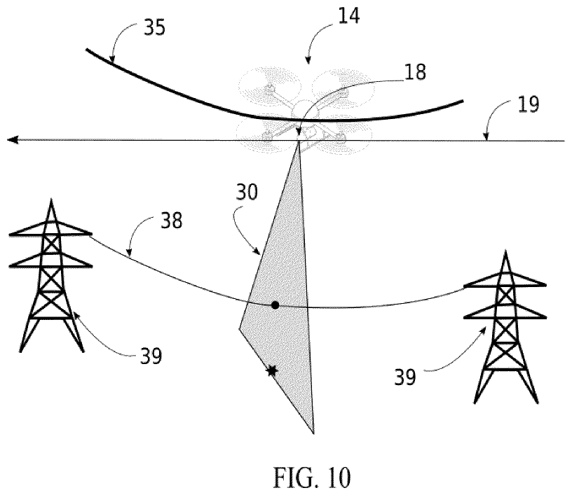

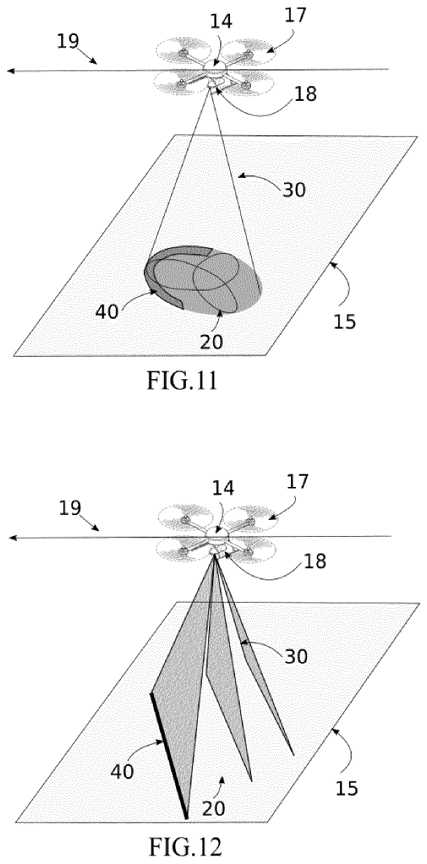

In FIG. 1 the UAV 14 follows a survey line 19. The LiDAR scanner 18 mounted on the UAV emits LASER beams 30 with varying directions so that the ground is scanned with a two-dimensional scanning pattern 20 within a forward-looking scanning sector 40, see FIG. 10 and FIG. 11. The light of the LASER beams 30 is reflected back to the LiDAR system 18 by the ground 15 and by objects 16, 17 on the ground 15. From the direction of the LASER beams 30 and the time of flight of the LASER light the positions on the ground 15 relative to the UAV 14 can be determined. The scanning of the ground with the LASER beams 30 results in a point cloud, wherein each point 22 of the point cloud represents a position on the ground 15 respectively the position of an object 16, 17 on the ground 15.

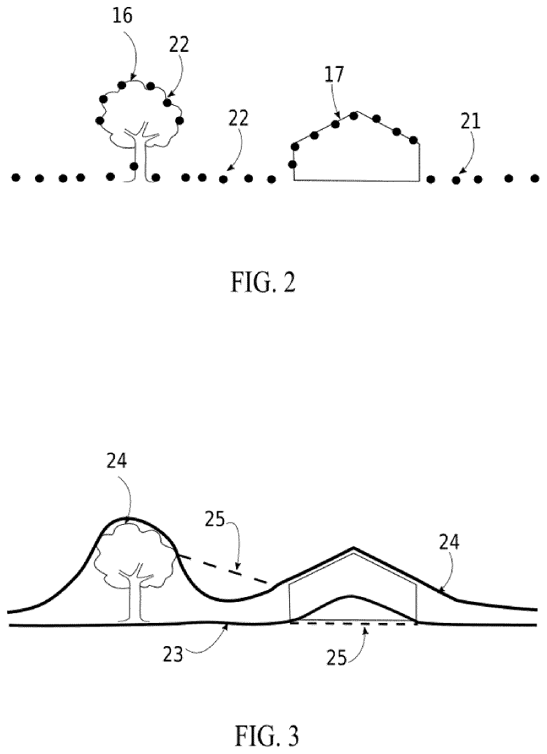

With the measurement of the LiDAR system 18 the position data is obtained in an aircraft-related coordinate system. Within the aircraft-related coordinate system the points 22 of the point cloud do not have an obvious correspondence with the ground 15 and the objects 16, 17 on the ground 15. By selecting the points 22 of the point cloud 21 with the corresponding position of the UAV 14 based on timestamps of the points and timestamps of the position of the aerial vehicle a scanline 21 can be obtained, see FIG. 2. Within the scanline 21 the spatial relation of the points 22 corresponds to the form of the scanned region the ground.

In FIG. 2 the scanline 21 obtained with the measurement of FIG. 1 is shown in a two-dimensional vertical section. The scanline 21 comprises a plurality of points 22 that are located on a horizontal line corresponding to the ground 15. The scanline 22 further comprises a plurality of points corresponding to the objects 16, 17. The points 22 corresponding to the upper ends of the objects 16, 17 have a vertical position that is clearly distinct from the vertical position of the points corresponding to the ground 15.

The scanline 21 is segmented to identify a first set of points 22 corresponding to the ground 15 and to identify a second set of points 22 corresponding to the upper ends of the objects 16, 17. The first set of points 22 is approximated with a first contour line 23. The second set of points 22 is approximated with a second contour line 24, see FIG. 3.

The first and second contour lines 23, 24 of FIG. 3 include regions where no position data coinciding with the contour line are present. In these regions the first contour line 23 is interpolated by line 25 so that an uninterrupted first contour line 23 is obtained corresponding to a ground line of the scanned region. Correspondingly, the second contour line 24 corresponding to the upper ends of the objects 16, 17 is interpolated by line 25 to obtain a second contour line 24 that is uninterrupted.

According to the invention the first and second contour lines 23, 24 and interpolated lines 25 are processed in a control unit 26 of the UAV 14 for the purpose of navigating the UAV 14.

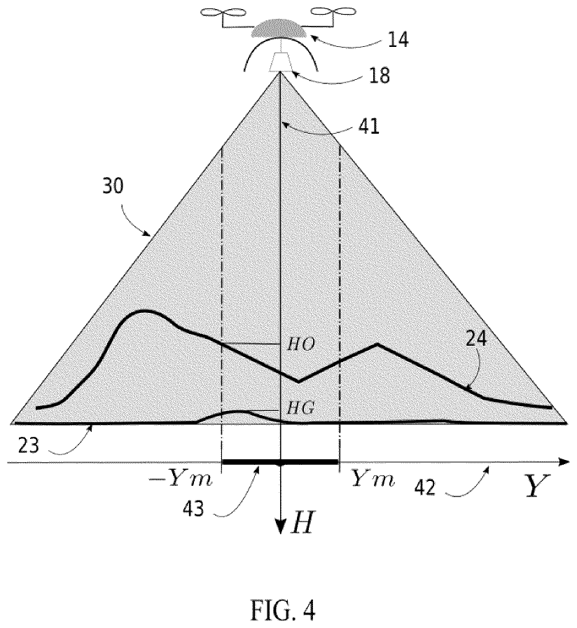

In FIG. 4, the UAV 14 is represented with an across track view of the scanning sector 30. The first and second contour lines 23 and 24 are used to determine the relative height with respect to ground, denoted by HG and the relative height with respect to objects, denoted by HO. The Nadir direction 41 is represented by the Axis H oriented downward. Along the across track axis 42 denoted by Y, we define a window 43 denoted by [−Ym, Ym] on which the maximum of the contour lines 24 and 23 are computed. The maximum value of 24 over the interval 43 provides the value of the relative height with respect to objects HO while the relative height with respect to the ground HG is the maximum value of the contour line 23 within the interval 43.

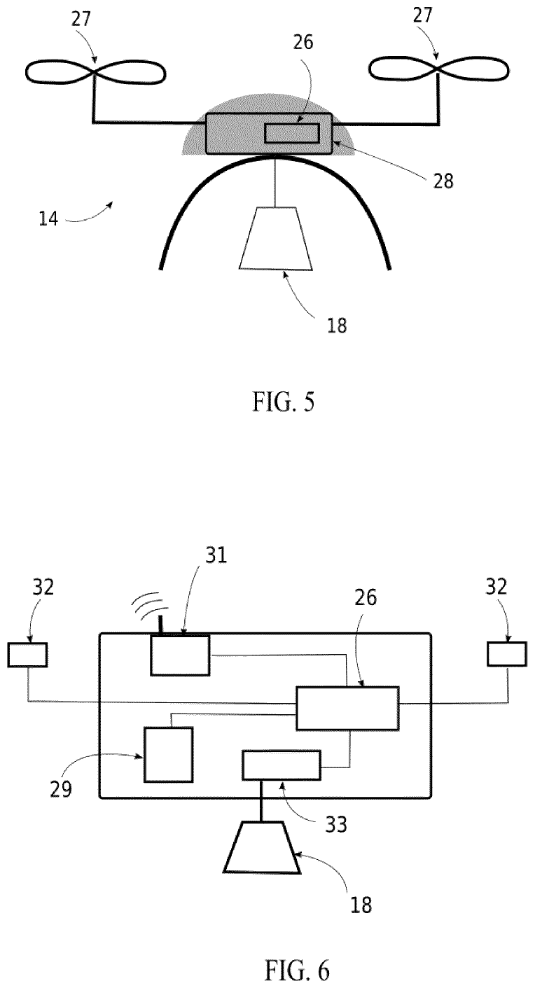

In FIG. 5, the UAV 14 has rotors 27 that are driven by electric motors 32. The energy for operating the electric motors 32 is provided by a battery that is arranged in a body 28 of the UAV 14. The LiDAR system 18 of the UAV 14 is powered by the same battery.

In FIG. 6, the control unit 26 of the UAV processes input data for determining aircraft control signals. The aircraft control signals are sent to the electric motors 32 for controlling the flight path of the UAV 14. The input data includes navigation data from the navigation system 29 of the UAV 14. The navigation system 29 comprises a GNSS for determining the position of the UAV 14 relative to the Earth and an IMU for measuring the orientation of the aircraft relative to the Earth or a linear acceleration and angular velocity of the aircraft.

The input data further includes flight mission data that is received via a radio frequency (RF) link with a receiver 31. For example, the flight mission data can define a track on the ground 15, which the UAV 14 should follow, while further details of the desired flight path remain undefined.

The input data further includes LiDAR data that is obtained with the LiDAR system 18. The LiDAR system 18 includes a computation module 33 which determines the scanline 21 from the LiDAR measurement data and which segments the first and second contour lines 23, 24 from the scanline 21. From the first and second contour lines 23, 24, the relative distance to the ground and the relative distance to objects are computed. For example, the distance to object can be the maximum value of the contour line 24 within an interval as shown in FIG. 4. The relative distance to the ground and to objects (HO and HG in FIG. 4) are provided to the control unit 26 as input data.

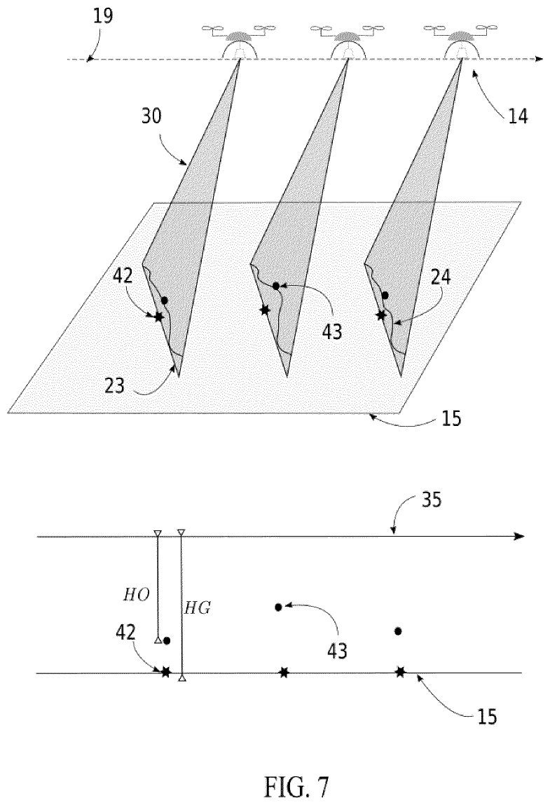

In the example of FIG. 7, the flight mission data received with receiver 31 defines an a priori flight path 35 along a track over ground and further defines that during the flight mission the UAV 14 should maintain a constant height over ground 15 and/or a constant height with respect to objects. At a given frequency of 0.5 Hz or preferably 1 Hz. The control unit 26 processes the first contour line 23 from the point cloud originating from the measuring optical device scanning sector. The control unit 26 determines points 42 and 43, in the Nadir direction located at distance HG and HO respectively. The values of the relative height with respect to the ground are determined with this frequency. The series of values of HO(t) produces a flight path 35 having a constant vertical distance relative to the ground 15. The second contour line 24 is processed for determining a series of values of relative height with respect to objects on the ground. In order to identify a possible conflict between the flight path 35 and objects 16, 17 on the ground, the controller 24 may command a change of relative height in order to maintain a constant relative height with respect to the ground. In FIG. 7 there is no such conflict so that the flight path 35 can have a constant altitude.

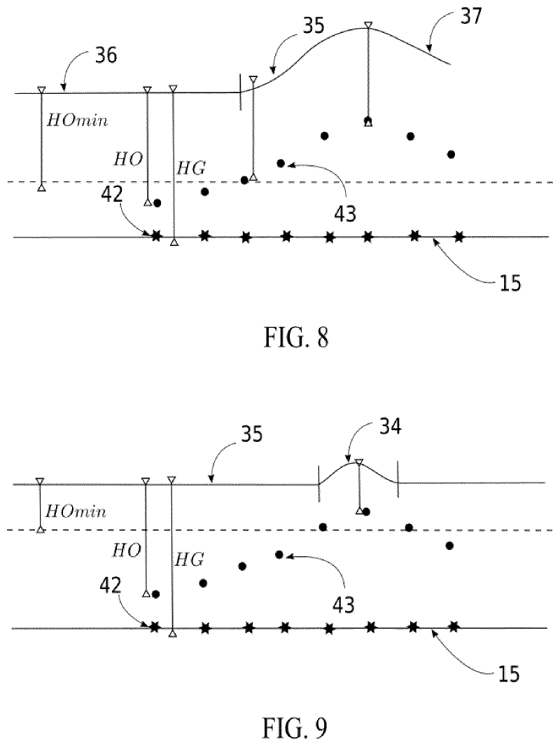

In FIG. 8 the flight mission data received with receiver 31 defines a first section 36 of flight path 35 in which the UAV 14 has a constant flight altitude over ground 15. In a second section 37 of flight path 35 the UAV 14 should maintain a constant vertical distance HOmin to the upper ends of the objects 16, 17 on the ground 15. The input information from the receiver 31, from the navigation system 29 and the computation module 33 is processed in the control unit 26 to provide corresponding aircraft control signals to electric motors 32.

In the example of FIG. 9, the flight mission data received with receiver 31 defines a flight path having a first minimum vertical distance over ground 15 and a second (smaller) minimum vertical distance over the ends of objects 16, 17 on the ground. The input data is processed in the control unit 26 to determine the flight path 35.

In FIGS. 7 to 9 the inventive method is performed online. This means that during the flight mission the LiDAR system 18 is active for continuously obtaining LiDAR measurement data. The LiDAR data is analyzed in the computation module 33 and the current first and second contour lines 23, 24 are continuously provided to the control unit 26. The control unit 26 processes the first and second contour lines 23, 24 in order to determine the aircraft control signals for the next section of the flight path.

In FIG. 10 the flight mission has the purpose of examining a power line of an electric transmission grid. The power line comprises cables 38 that are suspended from masts 39. In a first phase of the flight mission the UAV follows a survey path 19 with which the position and the direction of the cable are determined. In a second phase of the flight mission the information from the first phase is used to guide the aerial 14 along a flight path 35, where the UAV 14 has a constant vertical distance to the cable 38. The cable 38 is examined with the LiDAR system 18.

1. A method for controlling a flight path (35) of an aerial vehicle (14), the method comprising:
a) measuring a distance between the aerial vehicle (14) in flight and a plurality of points for obtaining a point cloud (21) of point position data;
b) segmenting a first contour line (23) and a second contour line (24) from the point cloud (21), wherein the first contour line (23) corresponds to the topographical ground and the second contour line (24) corresponds to a top line of objects (16, 17) on the ground;
c) processing data representing the first contour line (23) and/or data representing the second contour line (24) in a control unit (26) of the aerial vehicle for determining a control signal for the aerial vehicle (14);
d) controlling a vertical position of the flight path (35) of the aerial vehicle (14) with the control signal, wherein the flight path (35) of the aerial vehicle (14) includes a first section (36) in which the vertical position of the aerial vehicle (14) is determined relative to the first contour line (23) and wherein the flight path (35) of the aerial vehicle (14) includes a second section (37) in which the vertical position of the aerial vehicle (14) is determined relative to the second contour line (24).

2. The method of claim 1, wherein the flight path (35) of the aerial vehicle can include a third section (34) in which the vertical position of the aerial vehicle (14) is determined relative to the first contour line (23) and relative to the second contour line (24).

3. The method of claim 1, wherein the distance to the ground (15) is measured with a LiDAR system (18).

4. The method of claim 1, wherein the vertical position of the aerial vehicle (14) is determined based on the first contour line (23) and/or the second contour line (24).

5. The method of claim 1, wherein a lateral position of the aerial vehicle (14) is determined based on the first contour line (23) and/or the second contour line (24).

6. The method of claim 1, wherein a first contour surface and/or a second contour surface is determined, wherein the first contour surface and the second contour surface cover an area on the ground (15).

7. The method of claim 1, including the step of referencing the point cloud (21) to an Earth-related coordinate system.

8. A system for controlling a flight path (35) of an aerial vehicle (14), comprising:
a measuring device (18) for measuring a distance between the aerial vehicle (14) in flight and a plurality of points for obtaining a point cloud (21) of point position data,
a computation module (33) for segmenting a first contour line (23) and a second contour line (24) from the point cloud (21), wherein the first contour line (23) corresponds to the topographical ground and the second contour line (24) corresponds to a top line of objects (16, 17) on the ground, and
a control unit (26) adapted to process data representing the first contour line (23) and/or data representing the second contour line (24) for determining a control signal for the aerial vehicle (14) and adapted to control a vertical position of the flight path (35) of the aerial vehicle (14) with the control signal, wherein the flight path (35) of the aerial vehicle (14) includes a first section (36) in which the vertical position of the aerial vehicle (14) is determined relative to the first contour line (23) and wherein the flight path (35) of the aerial vehicle (14) includes a second section (37) in which the vertical position of the aerial vehicle (14) is determined relative to the second contour line (24).
